(19) United States
(12) Patent Application Publication
(10) Pub. No.: US 2010/0019409 A1
(43) Pub. Date: Jan. 28, 2010

(54) Method for fabricating a hollow replica of a pre-existing object and converting the replica into a lighted interchanging aesthetic display device

(76) Inventors: Cathy Dawn Santa Cruz, Reno, NV (US); Martin Carl Linenko, Reno, NV (US)

Correspondence Address: CATHY D. SANTA CRUZ, 7630 THOLL DR., RENO, NV, 89506, US

(21) Appl. No.: 12/220,358

(22) Filed: Jul. 24, 2008

(51) Int. Cl. B28B 17/00; H01B 19/00

(52) U.S. Cl. 264/162; 29/887

(57) ABSTRACT

A fabrication method involving unique steps for creating a hollow replica of a pre-existing object and then converting the replica into an aesthetically pleasing light show display device having internal lighted interchanging lights that illuminate the device producing a light-show that is eye-catching, soothing and mesmerizing.

### FIELD OF THE INVENTION

The present invention relates in general to fabrication methods for producing an aesthetically pleasing display device but more particularly pertains to the transformation thereof into a translucent device having internal lighted interchanging lights that illuminate the device producing a light-show that is eye-catching, soothing and mesmerizing.

### BACKGROUND OF THE INVENTION

Within the known prior art there have been attempts to fabricate replicas of pre-existing objects and utilizing the resultant replica for various purposes. Most replicas are fabricated for formational study, such as in the fields of exemplary fossil formation, meteorite assessment, forensic sciences and the like. Replicas of these types are most advantageous and beneficial for informational scientific studies. Furthermore, in most cases these replicas are fabricated by complicated procedures utilizing meticulous steps and most often various chemicals, clays, plaster, Epoxy™ and hardeners of that nature and are used to provide illumination to walkways and paths.

The present invention is completely different not only in the fabrication process thereof but more importantly the new end use of which is an unusual, novel, resultant aesthetic light-show device that also provides ambient light for walkway and path illumination. Namely, authentic reproduction of any object of replicator's choice of which the replicator wishes to convert into an illuminated device for the purpose of a light-show display. It is to be understood numerous objects may be replicated and the invention is not to be limited to any specific type of object. However, for exemplary purposes the object of the replicator's choice in this application is a natural pre-existing rock.

Within the known prior art the applicant's did not find any devices that are authentic replicas of an object and then are converted for the explicit sole purpose of their display utilizing lighted, interchanging lights producing a soothing mesmerizing light-show as taught herein while simultaneously providing ambient light for walkway and path illumination.

### OBJECTS OF THE INVENTION

It is therefore a primary object of the present invention to provide a method for replicating a preexisting object and then converting the replica into the new novelty light-show device of which heretofore has not been available, manufactured or conceived.

Another important object of the present invention is to provide a simplified method for replicating the object of choice, such as a natural pre-existing rock. The method does not require any unusual work skills and eliminates the need for any specialized tools, equipment, chemicals, moulds, etc., as all of the necessary supplies are readily available for the replicator's use.

Yet another object of the present invention is to provide simple easy to follow method steps for converting the replica into the final novel light show device.

Still another object of the present invention is to provide a replication method and conversion process that is economical and cost effective to produce, manufacture and sell.

A further object of the present invention is to provide the consumer with easy to follow instructions for installation and operation of the novel light show device.

Another object of the present invention is to provide an end product that utilizes pre-existing components, including standard electronics, light emitting diodes (LEDs), lights, batteries, etc. Also, the preferred embodiment for the device is solar-powered for convenience and ease of use for the consumer.

Still another object of the present invention is to provide a novel light show device of which the replica thereof can be reproduced by other manufacturing processes such as by plastic mould injection or the like.

Other objects and advantages will become apparent when taken into consideration with the following specifications and drawings.

### BRIEF DESCRIPTION OF THE DRAWINGS

FIG. 1 is substantially a block diagram illustrating the method steps (1-9) for reproduction of the authentic preexisting object, the formation of the replica and removal of the replica from the object.

FIG. 2 is substantially a block diagram illustrating the method steps (10-20) for duplicating the natural characteristics of the original object and transforming the replica into the desired replication.

FIG. 3 is substantially a block diagram illustrating the method steps (21-29) for transforming the replication into the finalized light show device.

FIG. 4 is substantially a plan view depicting assembly and construction of the finalized light show device.

### DETAILED DESCRIPTION OF THE DRAWINGS

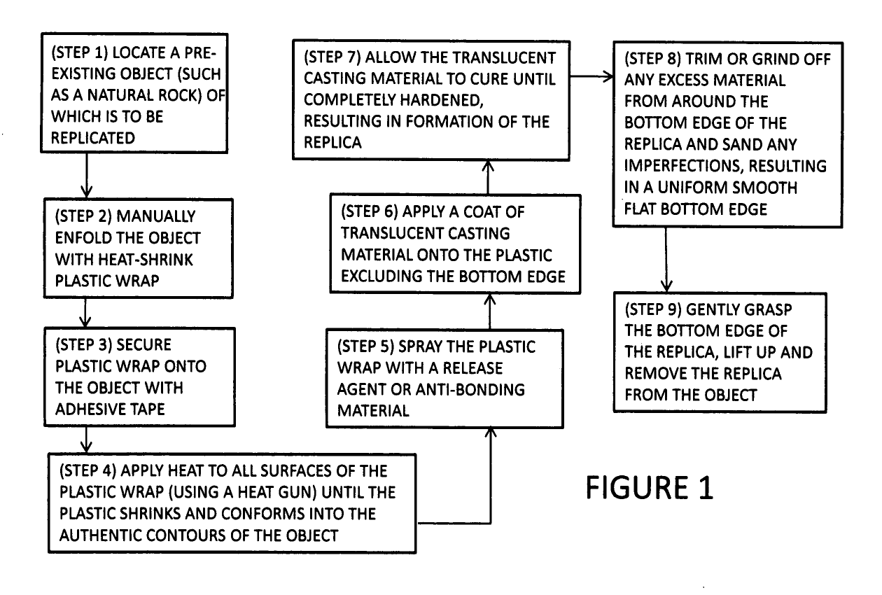

Referring now in detail to the drawings wherein like characters refer to like elements throughout the various views. The following as depicted in FIG. 1 describes in detail the method steps (1-9) for reproduction of the authentic pre-existing object, the formation of the replica and removal of the replica from the object.

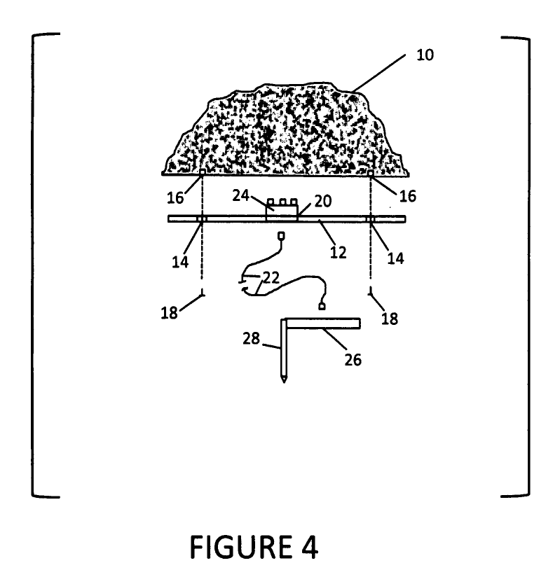

Step 1 is for the workman to locate a pre-existing object of which they wish to fabricate a replica thereof. It is to be understood that any suitable object of their liking can be replicated. Therefore the natural authentic rock (10) as depicted in FIG. 4 is only exemplary of one possible object of choice.

Step 2 requires the workman to manually enfold the object with heat-shrink plastic wrap. Again any suitable type of heat-shrink plastic wrap of workman's choice can be used, such as Cellophane™ or the like.

Step 3 requires the workman to secure the plastic wrap onto the object with any suitable adhesive tape of their choice. Preferably the adhesive tape is applied onto either the lower edge or underneath the object and secures the plastic wrap thereto.

Step 4 requires the workman to apply heat to the plastic wrap by any suitable means of choice, such as the workman can use a standard heat gun or the like. The workman applies the heat to all surfaces of the plastic until the plastic wrap shrinks and conforms to the authentic contours of the object.

Step 5 requires the workman to spray the plastic wrap with any suitable anti-stick spray, release agent or anti-bonding material of their choice, such as paraffin, silicone, kerosene, and vegetable oil based agents.

Step 6 requires the workman to apply by brush or spray a coat of any suitable translucent casting material of their choice, such as fibreglass, acrylic, plastic resins, concrete, epoxy, etc. The casting material is applied to all surfaces of the plastic wrap excluding the bottom edge.

Step 7 requires the workman to allow the translucent casting material to cure until completely hardened. Whereby, when hardened this results in the formation of the replica.

Step 8 requires the workman to either trim or grind off any excess material from around the bottom edge of the replica and sand any imperfections with sandpaper or the like. Whereby, when trimmed and sanded provides a uniform smooth flat bottom edge for the replica.

Step 9 requires the workman to gently manually grasp the bottom edge of the replica, lift up and remove the replica from the object. This finalizes the first stage of reproduction process and now the replica is substantially formed and is portable which allows the workman to proceed with the following steps.

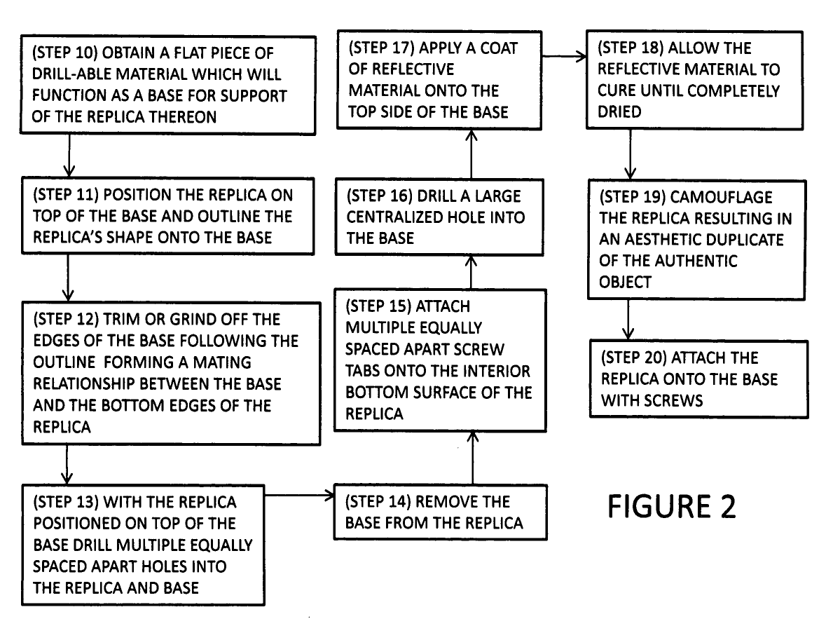

The following as depicted in FIG. 2 describes in detail the method steps (10-21) for duplicating the natural characteristics of the original object and transforming the replica into the desired replication.

Step 10 requires the workman to obtain any suitable type of flat piece of material which can be drilled and which will function as a base (base 12 is depicted in FIG. 4) for support of the replica thereon. Again any suitable flat piece of material of workman's choice can be used, such as fibreglass, acrylic, plastic resins, concrete, epoxy or the like.

Step 11 requires the workman to position the replica on top of the base (12) and outline the replica's shape onto the top side of the base (12).

Step 12 requires the workman to trim or grind off the edges of the base (following the outline) forming a mating relationship between the base and the bottom edges of the replica. Preferably the base (12) is slightly smaller than the bottom edges of the replica so as to substantially conceal the base (underneath the replica) from view when assembled.

Step 13 with the replica on top of the base (12) the workman then drills multiple equally spaced apart holes (holes 14 depicted in FIG. 4) into the replica and base (12). It is to be noted any number of holes may be drilled depending on workman's choice. Thus only two holes are depicted herein for clarity purposes but it is understood any number of holes necessary for a strong attachment is inherent

Step 14 requires the workman to remove the base (12) from the replica.

Step 15 requires the workman to attach multiple equally spaced apart screw tabs onto the interior bottom surface of the replica. Multiple tabs 16 are illustrated in FIG. 4. The multiple tabs (16) are of any suitable type of workman's choice and are carefully positioned to mate with the multiple holes (14) within the base (12) so as to allow the replica and the base to be screw-ably attached together. However, the holes (14), screw tabs (16) and screws (18) are only exemplary for one suitable type of fastening means for attaching the base and the replica together. Thus any type of fastening means of workman's choice is inherent.

Step 16 requires the workman to drill a large centralized hole (20) into the base of which is of a shape and size to frictionally receive an LED light housing (22) therein.

Step 17 requires the workman to apply a coat of reflective material onto the top side of the base. Again any suitable type of reflective material of workman's choice is inherent, such as mylar or metal foil. It is to be understood this reflective material is functional as it intensifies the effect of the internal lights and facilitates the overall efficiency for the mesmerizing light show.

Step 18 requires the workman to allow the reflective material time to cure until completely dried. However while awaiting cure time the workman can initiate the following step.

Step 19 requires the workman to camouflage the replica resulting in an aesthetic duplicate of the authentic object. It is to be noted any suitable means for camouflaging the replica is inherent. Thus the following specification is only exemplary for one possible camouflaging process. In this particular scenario (replication of an authentic natural rock (10) the following camouflage process is appropriate. Lightly sand or rough-up the external surface of the rock (if desired). Lightly spray paint mixture onto the replica in a non-uniform manner to mimic the selected rock. If any excess material tends to build up and it is not aesthetically appealing it can be gently dabbed away if needed. It has been realized that during this procedure it is more appealing if the mixture is very lightly applied. Furthermore, if desired numerous variations of colour can be intermingled for unique effects depending on workman's choice.

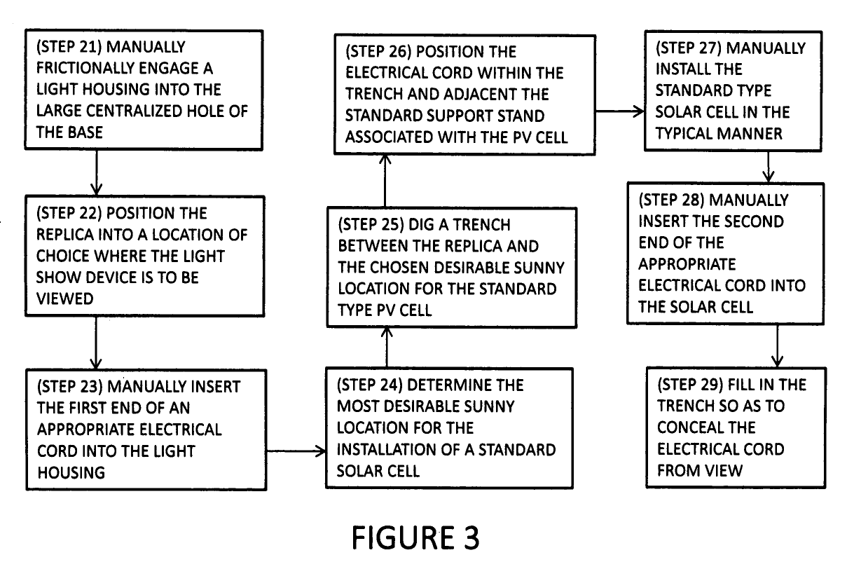

Step 20 requires the workman to attach the now camouflaged replica onto the base via the fasteners of choice, such as by snaps, rivets, screws (18) or the like. Whereby, phase 2 as depicted in FIG. 2 is now complete and the workman can proceed with the following method steps (21-29) as depicted in FIG. 3 for transforming the replication into the finalized light show device.

Step 21 requires the workman to manually frictionally engage the LED light housing into hole (20) of base (12).

Step 22 requires the workman (or consumer) to position the replica (rock 10) into a location of choice where the light show device is to be viewed.

Step 23 requires the workman to manually insert the first end of an appropriate electrical cord (22) into the LED light housing (24).

Step 24 requires the workman to determine the most desirable sunny location for the installation of a standard type solar cell (26).

Step 25 requires the workman to dig a trench between the replica (rock 10) and the chosen desirable sunny location for the standard type solar cell (26).

Step 26 requires the workman to position the electrical cord (22) within the trench and adjacent the standard support stand (28) associated with the solar cell (26).

Step 27 requires the workman to manually install the standard type solar cell (26) in the typical manner.

Step 28 requires the workman to manually insert the second end of the appropriate electrical cord (22) into the solar cell (26).

Step 29 requires the workman to fill in the trench so as to conceal the electrical cord (22) from view. This finalizes phase 3 and now the replica has been transformed into the finalized light show device. Whereby, upon energizing of the light show device during the night time hours, the light show device is visible and illuminates producing a light show that is eye-catching, soothing and mesmerizing.

It is to be understood that the preferred light show device is solar powered. However if desired other energizing means can be utilized, including batteries and/or electricity via a standard AC or DC outlet.

It is to be further understood that the light show device can incorporate any typical variations of prior art electronics, circuit boards and/or lights of engineering choice. Thus the invention is not to be limited to any specific electronics, circuit boards, lights, etc. However, for exemplary purposes the following electrical components are functional for the desired results.

The solar cell (26) contains the rechargeable battery(s) and the PCB (printed circuit board). The light housing (24) contains the typical bi-colour and tri-colour lights, or light emitting diodes (LEDs) as appropriate. The PBC is programmed (timed) to light the LED's at different intervals and may include a dust to dawn sensor for automatic operation. For example, when the photo-eye energizes, light #1 illuminates followed in secession (in various preset intervals) by light #3, then followed by light #2 in secession (in various preset intervals), excreta, for as many lights that are used. Thus, as each light fades off, another light illuminates causing a multitude of numerous colours and the unique light show effect.

Although the invention has been herein shown and described in what is conceived to be the most practical and preferred embodiment, it is recognized that departures may be made there from within the scope and spirit of the invention, which is not to be limited to the details disclosed herein but is to be accorded the full scope of the claims so as to embrace any and all equivalent devices and apparatuses.

Having described the invention, what we claim as new and desire to secure by Letters Patent is:

1. A method for fabricating a hollow replica of a pre-existing object comprising the steps of:
a. locating a preexisting object of which is to be replicated;
b. manually enfolding said object with heat-shrink plastic wrap;
c. securing said heat-shrink plastic wrap onto said object with adhesive tape;
d. applying heat to all surfaces of said heat-shrink plastic wrap until said heat shrink-plastic wrap shrinks and conforms into the authentic contours of said object;
e. spraying said heat shrink-plastic wrap with a release agent or anti-bonding material;
f. applying a coat of translucent casting material onto said heat shrink-plastic wrap;
g. allowing said translucent casting material to cure until completely hardened resulting in formation of a replica;
h. trimming off any excess material from around the bottom edge of said replica and sanding any imperfections, resulting in a uniform smooth flat bottom edge;
and;
i. grasping said uniform smooth flat bottom edge of said replica, lifting up and removing said replica from said object.

2. The method of claim 1 further includes converting said replica into a lighted interchanging aesthetic light show device comprising the steps of:
a. obtaining a flat piece of material which will function as a base for support of said replica thereon;
b. positioning said replica on top of said base, outlining the shape of said replica onto said base;
c. trimming off the edges of said base following said outline forming a mating relationship between said base and the bottom edges of said replica;
d. drilling multiple equally spaced apart holes into said replica and said base;
e. removing said base from said replica;
f. attaching multiple equally spaced apart screw tabs onto the interior bottom surface of said replica;
g. drilling a large centralized hole into said base;
h. applying a coat of reflective material onto the top side of said base;
i. allowing said reflective material to cure until completely dried;
j. camouflaging said replica;
k. attaching said replica onto said base;
l. engaging a light housing into said large centralized hole of said base;
m. positioning said replica into a location of choice where said lighted interchanging aesthetic light show device is to be viewed;
n. inserting a first end of an electrical cord into said light housing;
o. determining a desirable location for the installation of a solar cell;
p. digging a trench between said replica and desirable location for the installation of said solar cell;
q. positioning said electrical cord within said trench;
r. installing said solar cell;
s. inserting a second end of said electrical cord into said solar cell;
and;
t. filling in said trench so as to conceal said electrical cord from view.
